(19) United States
(12) Patent Application Publication
(10) Pub. No.: US 2022/0203529 A1
(43) Pub. Date: Jun. 30, 2022

(54) CONTROL DEVICE, TASK SYSTEM, CONTROL METHOD, AND CONTROL PROGRAM

(71) Applicant: TOYOTA JIDOSHA KABUSHIKI KAISHA, Toyota-shi (JP)

(72) Inventors: Yoshiaki NAKAMOTO, Nisshin-shi (JP); Yuta ITOZAWA, Nagoya-shi (JP); Hirotaka KOMURA, Tokyo (JP); Yutaro TAKAGI, Tokyo (JP); Junya OTA, Tokyo (JP); Kunihiro IWAMOTO, Nagakute-shi (JP)

(21) Appl. No.: 17/511,776

(22) Filed: Oct. 27, 2021

(30) Foreign Application Priority Data
Dec. 25, 2020 (JP) 2020-216572

(51) Int. Cl. B25J 9/16

(52) U.S. Cl. CPC B25J 9/1661; B25J 9/1682; B25J 9/1651

(57) ABSTRACT

A control device according to an embodiment of the present disclosure includes: a completion time calculation unit that calculates the time a task is completed; a position acquisition unit that acquires position information of a user; an arrival time calculation unit that calculates the time the user arrives; an execution time acquisition unit that acquires information indicating a time slot for causing a robot to execute the task; a determination unit that determines whether the task is completed by the time the user arrives; and a control unit that controls the robot based on a determination result of the determination unit or the time slot for causing the robot to execute the task. The execution time acquisition unit acquires information indicating the time slot for causing the robot to execute the task for each robot of a plurality of robots or for each task of a plurality of tasks.

### CROSS-REFERENCE TO RELATED APPLICATION

This application claims priority to Japanese Patent Application No. 2020-216572 filed on Dec. 25, 2020, incorporated herein by reference in its entirety.

### BACKGROUND

### 1. Technical Field

The present disclosure relates to a control device, a task system, a control method, and a control program, and for example, a control device, a task system, a control method, and a control program for making a robot execute tasks in a facility used by a user.

### 2. Description of Related Art

In recent years, robots may operate to execute tasks in facilities such as houses. For example, WO 2020-075515 discloses a technique for estimating a scheduled home arrival time of a user and having a cooking robot complete cooking by the scheduled home arrival time.

### SUMMARY

The applicant has found the following issues. The tasks executed by robots are diversifying, and there are cases where users want to continue tasks even after returning home. Therefore, it is desired to be able to optimize the time slot in which a robot executes a task in accordance with the needs of the user, for each robot of a plurality of robots, for the time slot in which the robot executes the task, and for each task of a plurality of tasks.

The present disclosure has been made in view of such problems, and realizes a control device, a task system, a control method, and a control program that are able to optimize the time slot in which a robot executes a task in accordance with the needs of the user, for each robot of a plurality of robots, for the time slot in which the robot executes the task, and for each task of a plurality of tasks.

A control device of an embodiment of the present disclosure is a device that controls a robot to execute a task in a facility used by a user, the control device including:

a command acquisition unit that acquires command information for the task;

a completion time calculation unit that calculates the time the task is completed;

a position acquisition unit that acquires position information of the user;

an arrival time calculation unit that calculates the time at which the user arrives at the facility based on the position information of the user;

an execution time acquisition unit that acquires information indicating a time slot in which the robot is caused to execute the task;

a determination unit that determines whether the task is completed by the time at which the user arrives at the facility; and

a control unit that controls the robot based on a determination result of the determination unit or the time slot in which the robot is caused to execute the task,

in which the execution time acquisition unit acquires information indicating the time slot in which the robot is caused to execute the task for each robot of a plurality of robots or for each task of a plurality of tasks.

In the control device described above, the completion time calculation unit may calculate a scheduled execution time of the task by the robot based on a current time and the time at which the task is completed, and

when the task is not completed by the time at which the user arrives at the facility and at least a part of the scheduled execution time of the task by the robot is within the time slot in which the robot is caused to execute the task, the control unit may control the robot so that the robot executes the task.

In the control device described above, the completion time calculation unit may calculate a scheduled execution time of the task by the robot based on a current time and the time at which the task is completed, and

when at least a part of the scheduled execution time of the task by the robot is within the time slot in which the robot is caused to execute the task, the control unit may control the robot to operate at a normal operation speed that is set in advance, at least within the time slot in which the robot is caused to execute the task.

In the control device described above, the completion time calculation unit may calculate a scheduled execution time of the task by the robot based on a current time and the time at which the task is completed, and

when at least a part of the scheduled execution time of the task by the robot is outside the time slot in which the robot is caused to execute the task, the control unit may control the robot to operate at a speed that is equal to or less than a maximum operation speed that is slower than a normal operation speed that is set in advance, at least outside the time slot in which the robot is caused to execute the task.

A task system according to one aspect of the present disclosure includes:

the above-mentioned control device;

a robot controlled by the control device;

a first detection unit that detects the user;

a second detection unit that is held by the user and that detects a position of the user; and

an execution time setting unit that is able to set the time slot in which the robot is caused to execute the task for each robot of the plurality of robots or for each task of the plurality of tasks.

The task system described above may include a maximum speed setting unit that sets a maximum operation speed of the robot.

A control method of one aspect of the present disclosure is a method that controls a robot to execute a task in a facility used by a user, the method including:

a step of acquiring command information of the task;

a step of calculating a required time of the task;

a step of acquiring position information of the user;

a step of calculating a time at which the user arrives at the facility based on the position information of the user;

a step of acquiring information indicating a time slot in which the robot is caused to execute the task;

a step of determining whether the task is completed by the time at which the user arrives at the facility; and

a step of controlling the robot based on a determination result of whether the task is completed or the time slot in which the robot is caused to execute the task,

in which time slot in which the robot is caused to execute the task is acquired for each robot of a plurality of robots or for each task of a plurality of tasks.

A control program of one aspect of the present disclosure is a program that controls a robot to execute a task in a facility used by a user, the control program including:

a process of acquiring command information of the task;

a process of calculating a required time of the task;

a process of acquiring position information of the user;

a process of calculating a time at which the user arrives at the facility based on the position information of the user;

a process of acquiring information indicating a time slot in which the robot is caused to execute the task;

a process of determining whether the task is completed by the time at which the user arrives at the facility; and

a process of controlling the robot based on a determination result of whether the task is completed or the time slot in which the robot is caused to execute the task,

in which the control program causes a computer to execute a process of acquiring information indicating the time slot in which the robot is caused to execute the task for each robot of a plurality of robots or for each task of a plurality of tasks.

According to the present disclosure, it is possible to realize a control device, a task system, a control method, and a control program that are able to optimize the time slot in which a robot executes a task in accordance with the needs of the user, for each robot of a plurality of robots, for the time slot in which the robot executes the task, and for each task of a plurality of tasks.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration of a task system according to a first embodiment;

FIG. 2 is a block diagram showing functional elements of a control device according to the first embodiment;

FIG. 3 is a flowchart showing a flow of executing a task using the task system according to the first embodiment;

FIG. 4 is a diagram schematically showing a configuration of a task system according to a second embodiment;

FIG. 5 is a diagram schematically showing a configuration of a task system according to a third embodiment; and

FIG. 6 is a diagram showing an example of a hardware configuration included in the control device and the task system.

### DETAILED DESCRIPTION OF EMBODIMENTS

Hereinafter, specific embodiments to which the present disclosure is applied will be described in detail with reference to the drawings. However, the present disclosure is not limited to the following embodiments. Further, in order to clarify the explanation, the following description and drawings are simplified as appropriate.

### First Embodiment

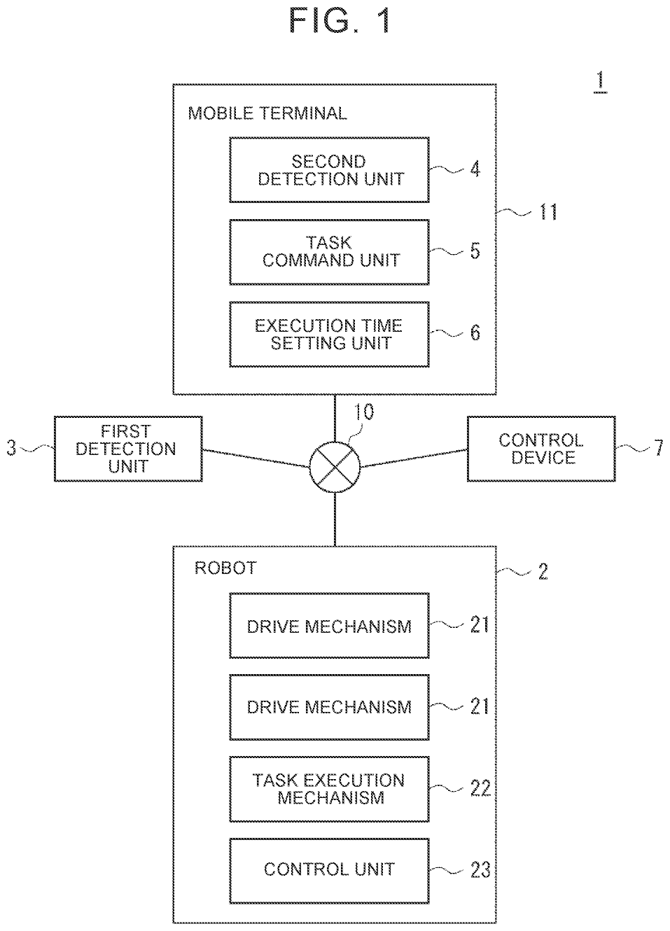

FIG. 1 is a diagram schematically showing a configuration of a task system according to the present embodiment. As shown in FIG. 1, a task system 1 can be used, for example, when a robot 2 is used to execute a task in a facility used by a user such as a house. Therefore, the number of users is one or more. Here, in the following description, the case of a house as the facility will be described as a representative.

For example, as shown in FIG. 1, the task system 1 includes the robot 2, a first detection unit 3, a second detection unit 4, a task command unit 5, an execution time setting unit 6, and a control device 7. The robot 2 is, for example, a robot that autonomously moves by rotating left and right drive wheels.

The robot 2 includes, for example, left and right drive mechanisms 21 that rotate the left and right drive wheels, a task execution mechanism 22 such as a robot arm for executing a plurality of tasks, and a control unit 23 that controls the left and right drive mechanisms 21 and the task execution mechanism 22. The task is a task such as housework support or transportation of luggage, and may be a task that can be executed by a known robot.

Further, the robot 2 may be a humanoid robot as long as it is configured to be able to execute a plurality of tasks. The robot 2 is connected to the network 10. Here, the network 10 is, for example, the Internet, and is constructed by a telephone line network, a wireless communication path, Ethernet (registered trademark), or the like.

The first detection unit 3 is disposed in each room of the house and detects a user present in the house. The first detection unit 3 can be configured by a motion sensor such as an infrared camera. However, the first detection unit 3 may be a sensor capable of detecting a person present in the house. The first detection unit 3 is connected to the network 10.

The second detection unit 4 detects the position of the user. As shown in FIG. 1, the second detection unit 4 can be configured by, for example, a global positioning system (GPS) receiver mounted on a mobile terminal 11 such as a smartphone owned by the user.

However, the second detection unit 4 can use a known position information system such as another satellite positioning system as long as the system can detect the current position of the user. The second detection unit 4 is connected to the network 10.

The task command unit 5 is operated by the user or another person in order to input (command) the content (type) of the task to be executed by the robot 2. As shown in FIG. 1, for example, the task command unit 5 is preferably mounted on the mobile terminal 11. The user can perform input by selecting the content of the task displayed on a display unit of the mobile terminal 11. The task command unit 5 is connected to the network 10. The task command unit 5 only needs to be capable of inputting information necessary for executing the task.

The execution time setting unit 6 is operated by the user or another person to set a time slot when the robot 2 is caused to execute a task. As shown in FIG. 1, for example, the execution time setting unit 6 is preferably mounted on the mobile terminal 11. The user can set the time slot when the robot 2 is caused to execute a task via the mobile terminal 11, for each task of the plurality of tasks. The execution time setting unit 6 is connected to the network 10.

Here, the “time slot when the robot 2 is caused to execute a task” in the present embodiment is a time slot having a range from the start time of the earliest task to the completion time of the latest task desired by the user. That is, the “time slot when the robot 2 is caused to execute a task” in the present embodiment is an operation time slot of the robot 2 from the start to the completion of the task desired by the user.

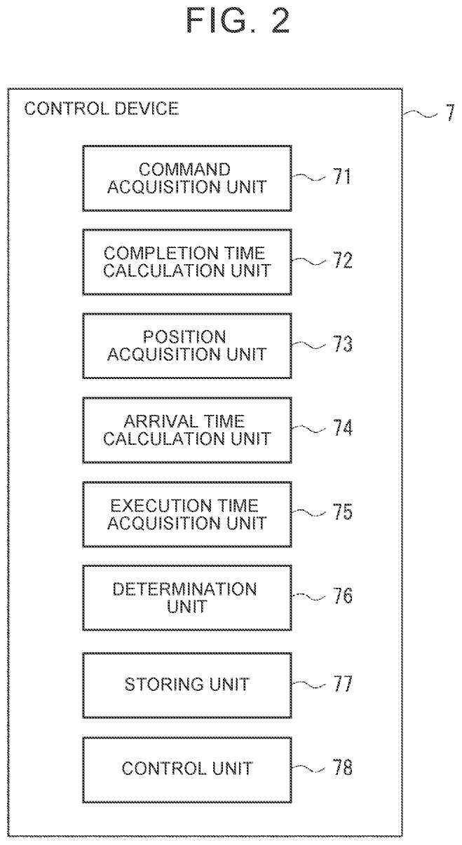

Here, FIG. 2 is a block diagram showing functional elements of the control device according to the present embodiment. As shown in FIG. 2, the control device 7 includes a command acquisition unit 71, a completion time calculation unit 72, a position acquisition unit 73, an arrival time calculation unit 74, an execution time acquisition unit 75, a determination unit 76, a storage unit 77, and a control unit 78. The control device 7 is connected to the network 10.

The command acquisition unit 71 acquires information indicating the content of the task to be executed by the robot 2 received from the task command unit 5. Note that, the command acquisition unit 71 may include the task command unit 5. In short, the command acquisition unit 71 only needs to acquire the content of the task input by the user.

The completion time calculation unit 72 calculates the time the task is completed. The completion time calculation unit 72 calculates a required time of the task based on the content of the task commanded by the user, a preset movement speed of the robot 2, an operation speed of the task execution mechanism 22 of the robot 2, and the like, and calculates the time the task is completed based on the calculated required time of the task and the current time.

At this time, the completion time calculation unit 72 may calculate the scheduled execution time of the task by the robot 2 based on the current time and the time at which the task is completed. That is, the “scheduled execution time of the task” is the scheduled operation time of the robot 2 from the current time at which the robot 2 starts the task to the time at which the required time of the task elapses and the task is completed.

The position acquisition unit 73 acquires the current position information of the user based on the detection information received from the second detection unit 4. At this time, the position acquisition unit 73 may acquire the position of the user in real time. The position acquisition unit 73 may include the second detection unit 4. In short, the position acquisition unit 73 only needs to acquire the current position of the user.

The arrival time calculation unit 74 calculates the time the user arrives at the house. The arrival time calculation unit 74 calculates the time the user arrives at the house based on, for example, the current position of the user and a moving speed of the user. At this time, the arrival time calculation unit 74 may update the time the user arrives at the facility based on the position information of the user acquired in real time.

However, the arrival time calculation unit 74 may calculate the time the user arrives at the house in the shortest route from the current position of the user using timetable information and required time information of public transportation and the like, and may calculate the time the user arrives at the house using a known calculation method.

The execution time acquisition unit 75 acquires a time slot in which the robot 2 is caused to execute the task, which is set for each task of the plurality of tasks indicated by the information received from the execution time setting unit 6. The execution time acquisition unit 75 may include the execution time setting unit 6. In short, the execution time acquisition unit 75 only needs to acquire a time slot in which the robot 2 is caused to execute a task, which is set for each task of the plurality of tasks.

The determination unit 76 determines whether the user exists in the house, determines whether the task is completed by the time at which the user arrives at the house, and determines whether the scheduled execution time of the task is within the time slot for causing the robot 2 execute the task.

The storage unit 77 stores type information of a plurality of tasks to be executed by the robot 2, movement speed information of the robot 2, operation speed information of the task execution mechanism 22 of the robot 2, time slot information for causing the robot 2 execute the task for each task of the plurality of tasks, and the like. The storage unit 77 may store required time information for each task of the plurality of tasks.

Although the details will be described later, the control unit 78 controls the robot 2 based on the determination result of the determination unit 76. Further, the control unit 78 controls the first detection unit 3 and the second detection unit 4 based on the task command indicated by the information transmitted from the task command unit 5.

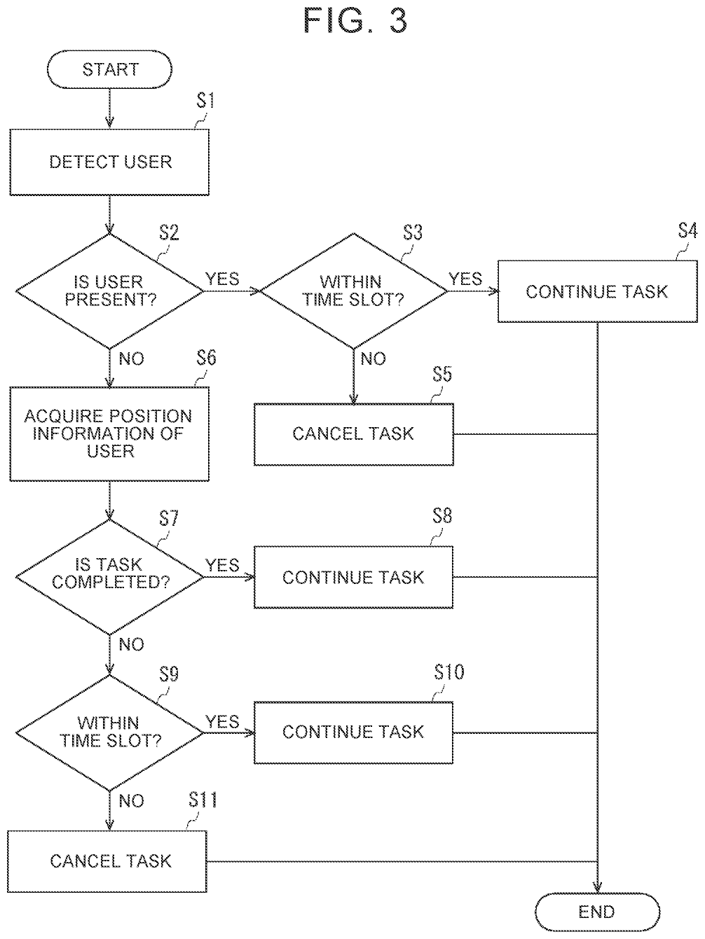

Next, a flow of executing a task using the task system 1 according to the present embodiment will be described. FIG. 3 is a flowchart showing a flow of executing a task using the task system according to the present embodiment.

Further, for each task of the plurality of tasks, it is assumed that the user sets the time slot when the robot 2 is caused to execute the task in advance via the execution time setting unit 6 mounted on the mobile terminal 11, and the information indicating the time slot when the robot 2 is caused to execute the task, in which the information is set for each task of the plurality of tasks, is stored in the storage unit 77.

First, when the user inputs the content of the task via the task command unit 5 mounted on the mobile terminal 11, the task command unit 5 transmits information indicating the content of the task to the control device 7. With this process, the task system 1 starts executing the task.

The control unit 78 of the control device 7 controls the first detection unit 3 so as to detect the user in the house. When the first detection unit 3 executes detection of the user who is present in the house, the first detection unit 3 transmits the detection information to the control device 7 (S1).

Next, the determination unit 76 of the control device 7 determines whether the user is present in the house based on the received detection information (S2). Then, when the determination unit 76 detects the person based on the detection information, the determination unit 76 determines that the user is present in the house (YES in S2). Here, in the case of the plurality of users, for example, when one user is present in the house, the determination unit 76 can determine that the user is present in the house.

Next, when it is determined that the user is present in the house, the completion time calculation unit 72 of the control device 7 calculates a required time of the task based on the content of the task commanded by the user, a movement speed of the robot 2, an operation speed of the task execution mechanism 22 of the robot 2, and the like, and calculates the scheduled execution time of the task based on the calculated required time of the task and the current time.

Then, the determination unit 76 of the control device 7 determines whether the calculated scheduled execution time of the task is within the time slot in which the robot 2 is caused to execute the task (S3). When the scheduled execution time of the task is within the time slot in which the robot 2 is caused to execute the task (YES in S3), the control unit 78 of the control device 7 transmits the control information to the control unit 23 of the robot 2 so as to continue the task.

The control unit 23 of the robot 2 controls the drive mechanisms 21 and the task execution mechanism 22 so that the task is continued (S4). After that, when the task is completed, the control unit 23 of the robot 2 transmits information indicating that the task is completed to the control device 7. When the control device 7 receives the information indicating that the task is completed, the control device 7 ends the task using the robot 2. As a result, the task can be completed within the time slot in which the robot 2 set by the user executes the task.

In contrast, when at least a part of the calculated scheduled execution time of the task is outside the time slot in which the robot 2 is caused to execute the task (NO in S3), the control device 7 cancels the task (S5). With this process, it is possible to suppress the robot 2 from executing the task outside the time slot in which the task is executed by the robot 2, and it is also possible to suppress the discomfort of the user caused by operation sounds of the robot 2 when the robot 2 executes the task.

When the determination unit 76 of the control device 7 does not detect the person based on the detection information, the determination unit 76 determines that the user is not present in the house (NO in S2). Then, the control unit 78 of the control device 7 controls the second detection unit 4 in order to acquire the position information of the user.

When the second detection unit 4 acquires the detection information of the position of the user from a GPS satellite, for example, the second detection unit 4 transmits the position information of the user to the control device 7. With this process, the position acquisition unit 73 of the control device 7 acquires the position information of the user (S6).

Next, the completion time calculation unit 72 of the control device 7 calculates a required time of the task based on the content of the task commanded by the user, a movement speed of the robot 2, an operation speed of the task execution mechanism 22 of the robot 2, and the like, and calculates the completion time of the task and the scheduled execution time of the task based on the calculated required time of the task and the current time.

Next, the arrival time calculation unit 74 of the control device 7 calculates the time the user arrives at the house based on the position of the user indicated by the received information. Here, in the case of the plurality of users, the arrival time of the user who arrives at the house earliest can be set as the time the user arrives at the house as a representative. Note that, calculation of the task completion time and calculation of the arrival time of the user may be reversed.

Then, the determination unit 76 of the control device 7 determines whether the task is completed by the time the user arrives at the house (S7). Specifically, the determination unit 76 determines whether the time the task is completed is earlier than the time the user arrives at the house.

When the time the task is completed is earlier than the time the user arrives at the house, the determination unit 76 of the control device 7 determines that the task is completed by the time the user arrives at the house (YES in S7). Then, the control unit 78 of the control device 7 transmits the control information to the control unit 23 of the robot 2 so as to continue the task.

The control unit 23 of the robot 2 controls the drive mechanisms 21 and the task execution mechanism 22 so that the task is continued (S8). After that, when the task is completed, the control unit 23 of the robot 2 transmits information indicating that the task is completed to the control device 7. When the control device 7 receives the information indicating that the task is completed, the control device 7 ends the task using the robot 2.

This allows the robot 2 to complete the task by the time the user arrives at the house. Therefore, the user does not feel uncomfortable with the operation sound of the robot 2 when the robot 2 executes the task.

In contrast, when the time the task is completed is later than the time the user arrives at the house, the determination unit 76 of the control device 7 determines that the task is not completed by the time the user arrives at the house (NO in S7). Then, the determination unit 76 determines whether the scheduled execution time of the task is within the time slot in which the robot 2 is caused to execute the task (S9).

When the scheduled execution time is within the time slot when the robot 2 is caused to execute the task (YES in S9), the control unit 78 of the control device 7 transmits the control information to the control unit 23 of the robot 2 so as to continue the task.

The control unit 23 of the robot 2 controls the drive mechanisms 21 and the task execution mechanism 22 so that the task is continued (S10). After that, when the task is completed, the control unit 23 of the robot 2 transmits information indicating that the task is completed to the control device 7. When the control device 7 receives the information indicating that the task is completed, the control device 7 ends the task using the robot 2.

Thereby, for example, even when the completion time of the task is after the arrival time of the user, when the user wishes the task to be completed, the task can be continued and completed.

In contrast, when at least a part of the scheduled execution time of the task is outside the time slot in which the robot 2 is caused to execute the task (NO in S9), the control device 7 cancels the task (S11). With this process, it is possible to suppress the robot 2 from executing the task outside the time slot in which the task is executed by the robot 2, and it is also possible to suppress the discomfort of the user caused by operation sounds of the robot 2 when the robot 2 executes the task.

As described above, since the control device 7, the task system 1, and the control method of the present embodiment can set the time slot in which the robot 2 is caused to execute the task for each task of the plurality of tasks, the time slot in which the robot 2 is caused to execute the task for each task of the plurality of tasks can be optimize in accordance with the needs of the user.

Moreover, when at least a part of the scheduled execution time of the task is outside the time slot in which the robot 2 is caused to execute the task, the operation of the robot 2 is restricted (for example, the task is canceled). Thus, it is possible to suppress the user from feeling unpleasant due to the operation sound of the robot 2 outside the time slot.

### Second Embodiment

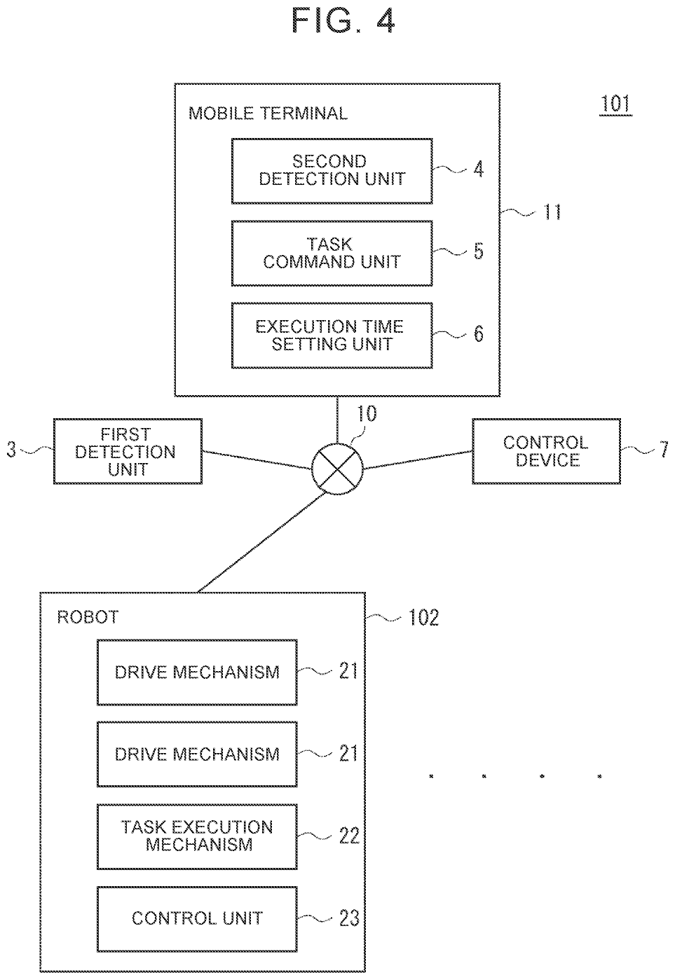

FIG. 4 is a diagram schematically showing a configuration of a task system according to the present embodiment. In the task system 1 of the first embodiment, one robot 2 executes a plurality of tasks. However, in a task system 101 of the present embodiment, for example, a plurality of robots 102 execute one task.

In this case, although the task can be executed substantially in the same manner as in the first embodiment, the time slot in which the robot 102 is caused to execute the task may be set for each robot 102 instead of setting the time slot in which the robot is caused to execute the task for each task of the plurality of tasks.

Thereby, in the present embodiment, the time slot in which the robot 102 is caused to execute the task can be set for each robot 102 of the plurality of robots 102, and as a result, similar to the first embodiment, it is possible to optimize the time slot in which the robot 102 executes the task for each task of the plurality of tasks so that the user's needs can be met.

However, the robot 102 may execute a plurality of tasks, and in that case, the desired robot 102 can execute the desired task in combination with the first embodiment.

### Third Embodiment

In the above embodiment, when at least a part of the scheduled execution time of the task is outside the time slot in which the robot is caused to execute the task, the task is canceled, but the operation of the robot may be restricted to execute the task so that the robot operates at a set maximum operation speed or less, in at least outside the time slot in which the robot is caused to execute the task.

At this time, the robot is operated at the set normal operation speed within the time slot in which the robot is caused to execute the task, and the robot is operated at the set maximum operation speed outside the time slot in which the robot is caused to execute the task. Here, the “normal operation” is an operation in a state where the operation speed is not limited.

The maximum operation speed of the robot may be any speed at which the robot operates at a speed equal to or lower than the noise level at which the user does not feel uncomfortable with the operation sound of the robot when the robot executes the task while the user is present in the house, and is slower than the normal operation speed of the robot.

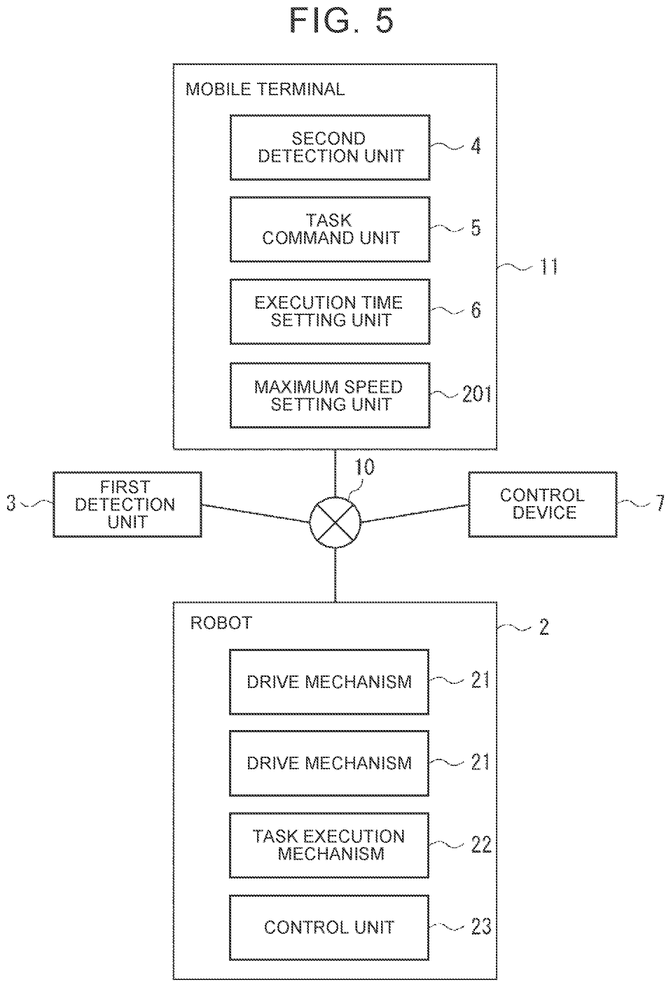

For example, the maximum operation speed of the robot or the like may be set to the operation speed of the robot or the like at which the user does not feel uncomfortable with the operation sound of the robot or the like by actually causing the robot or the like to execute the task, via a maximum speed setting unit 201 mounted on the mobile terminal 11 as shown in FIG. 5.

Note that, the maximum operation speed of the robot may be set through the supervised learning of a model in which the volume of the operation sound of the robot is an input and the maximum operation speed of the robot is an output, with an evaluation with which a plurality of persons does not feel uncomfortable as a correct answer.

By setting the maximum operation speed of the robot in this way, it is possible to complete the task while suppressing the user from feeling uncomfortable with the operating sound of the robot even outside the time slot in which the robot is made to execute the task.

### OTHER EMBODIMENTS

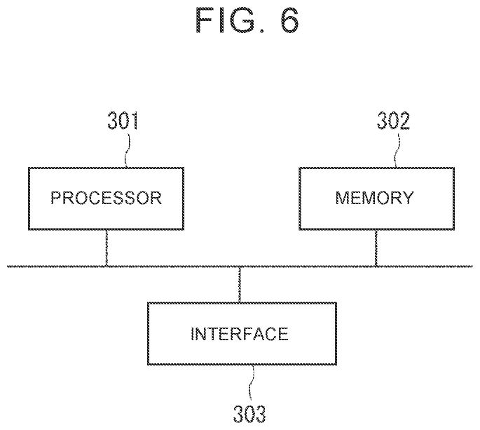

The control device and task system according to the above embodiment may have the following hardware configuration. FIG. 6 is a diagram showing an example of the hardware configuration included in the control device and the task system. As the procedure of processing in the control device and the task system has been described in various embodiments described above, the present disclosure may also take the form of a control method.

The control device shown in FIG. 6 includes a processor 301 and a memory 302 together with an interface 303. A part of the task system and the configuration of the control device described in the above-described embodiment are realized in a manner such that the processor 301 reads and executes a control program stored in the memory 302. That is, the control program is a program for causing the processor 301 to function as a part of the task system or as the configuration of the control device. It can be said that the control program is a program for causing the task system and the control device to execute the process in the configuration or a part thereof.

The program described above is stored using various types of non-transitory computer-readable media and can be supplied to a computer (a computer including an information notification device). The non-transitory computer-readable media include various types of tangible storage media. Examples of non-transitory computer-readable media include magnetic recording media (e.g., flexible disks, magnetic tapes, hard disk drives), magneto-optical recording media (e.g., magneto-optical disks). Further, the examples above include a compact disc read-only memory (CD-ROM), a compact disc recordable (CD-R), and a compact disc rewritable (CD-R/W). Further, the examples above include semiconductor memories (e.g., mask ROM, programmable ROM (PROM), erasable programmable ROM (EPROM), flash ROM, random access memory (RAM)). The program may also be supplied to the computer by various types of transitory computer-readable media. Examples of transitory computer-readable media include electrical and optical signals and electromagnetic waves. The transitory computer-readable media can supply a program to a computer via a wired communication path such as an electric wire and an optical fiber, or a wireless communication path.

The present disclosure is not limited to the above embodiment, and can be appropriately modified without departing from the spirit.

For example, as the “time slot when the robot 2 is caused to execute a task” in the present embodiment, a time slot having a range from the start time of the earliest task to the completion time of the latest task desired by the user is set. However, a time slot having a range from the start time of the earliest task to the start time of the latest task desired by the user may be set. That is, the “time slot when the robot 2 is caused to execute a task” may be a task start time slot desired by the user.

In this case, in steps S3 and S9, it is determined whether the current time is before or within the time slot in which the robot 2 is caused to execute the task. When the current time is before the time slot in which the robot 2 is caused to execute the task, when the time approaches the time slot for the robot 2 to execute the task, the robot 2 may be caused to execute the task. Alternatively, when the current time is within the time slot in which the robot 2 is caused to execute the task, the robot 2 may be caused to continue the task and execute the task.

Further, for example, as the “time slot when the robot 2 is caused to execute a task”, a time slot having a range from the completion time of the earliest task to the completion time of the latest task desired by the user may be set. That is, the “time slot when the robot 2 is caused to execute a task” may be a task completion time slot desired by the user. In this case, in steps S3 and S9, it is may be determined whether the completion time of the task is within the time slot in which the robot 2 is caused to execute the task. As described above, the “time slot in which the robot 2 is caused to execute the task” may be all or at least a part of the operation time of the task.

What is claimed is:

1. A control device that is a device that controls a robot to execute a task in a facility used by a user, the control device comprising:
a command acquisition unit that acquires command information for the task;
a completion time calculation unit that calculates the time the task is completed;
a position acquisition unit that acquires position information of the user;
an arrival time calculation unit that calculates the time at which the user arrives at the facility based on the position information of the user;
an execution time acquisition unit that acquires information indicating a time slot in which the robot is caused to execute the task;
a determination unit that determines whether the task is completed by the time at which the user arrives at the facility; and
a control unit that controls the robot based on a determination result of the determination unit or the time slot in which the robot is caused to execute the task,
wherein the execution time acquisition unit acquires information indicating the time slot in which the robot is caused to execute the task for each robot of a plurality of robots or for each task of a plurality of tasks.

2. The control device according to claim 1,
wherein the completion time calculation unit calculates a scheduled execution time of the task by the robot based on a current time and the time at which the task is completed, and
wherein when the task is not completed by the time at which the user arrives at the facility and at least a part of the scheduled execution time of the task by the robot is within the time slot in which the robot is caused to execute the task, the control unit controls the robot such that the robot executes the task.

3. The control device according to claim 1,
wherein the completion time calculation unit calculates a scheduled execution time of the task by the robot based on a current time and the time at which the task is completed, and
wherein when at least a part of the scheduled execution time of the task by the robot is within the time slot in which the robot is caused to execute the task, the control unit controls the robot such that the robot operates at a normal operation speed that is set in advance, at least within the time slot in which the robot is caused to execute the task.

4. The control device according to claim 1,
wherein the completion time calculation unit calculates a scheduled execution time of the task by the robot based on a current time and the time at which the task is completed, and
wherein when at least a part of the scheduled execution time of the task by the robot is outside the time slot in which the robot is caused to execute the task, the control unit controls the robot such that the robot operates at a speed equal to or less than a maximum operation speed that is slower than a normal operation speed that is set in advance, at least outside the time slot in which the robot is caused to execute the task.

5. A task system comprising:
the control device according to claim 1;
a robot controlled by the control device;
a first detection unit that detects the user;
a second detection unit that is held by the user and that detects a position of the user; and
an execution time setting unit that is able to set the time slot in which the robot is caused to execute the task for each robot of the plurality of robots or for each task of the plurality of tasks.

6. The task system according to claim 5, comprising a maximum speed setting unit that sets a maximum operation speed of the robot.

7. A method that controls a robot to execute a task in a facility used by a user, the method comprising:
a step of acquiring command information of the task;
a step of calculating a required time of the task;
a step of acquiring position information of the user;
a step of calculating a time at which the user arrives at the facility based on the position information of the user;
a step of acquiring information indicating a time slot in which the robot is caused to execute the task;
a step of determining whether the task is completed by the time at which the user arrives at the facility; and
a step of controlling the robot based on a determination result of whether the task is completed or the time slot in which the robot is caused to execute the task,
wherein information indicating the time slot in which the robot is caused to execute the task is acquired for each robot of a plurality of robots or for each task of a plurality of tasks.

8. A control program that is a program that controls a robot to cause the robot to execute a task in a facility used by a user, the control program comprising:
a process of acquiring command information of the task;
a process of calculating a required time of the task;
a process of acquiring position information of the user;
a process of calculating a time at which the user arrives at the facility based on the position information of the user;
a process of acquiring information indicating a time slot in which the robot is caused to execute the task;
a process of determining whether the task is completed by the time at which the user arrives at the facility; and
a process of controlling the robot based on a determination result of whether the task is completed or the time slot in which the robot is caused to execute the task,
wherein the control program causes a computer to execute a process of acquiring information indicating the time slot in which the robot is caused to execute the task for each robot of a plurality of robots or for each task of a plurality of tasks.
